(19) United States
(12) Patent Application Publication
(10) Pub. No.: US 2021/0239613 A1
(43) Pub. Date: Aug. 5, 2021

(54) ACTUATOR FOR MOTION CONTROL OF AN OPTICAL SURFACE OF A SENSOR

(71) Applicant: Carrier Corporation, Palm Beach Gardens, FL (US)

(72) Inventors: Rajiv Ranjan, South Windsor, CT (US); Suman Dwari, Vernon, CT (US); Peter R. Harris, West Hartford, CT (US)

(21) Appl. No.: 17/054,429

(22) PCT Filed: May 6, 2019
(86) PCT No.: PCT/US2019/030907

§ 371 Date: Nov. 10, 2020

Related U.S. Application Data
(60) Provisional application No. 62/671,846, filed on May 15, 2018.

(51) Int. Cl. G01N 21/53; G01S 17/04; G01S 17/88; G01S 7/481

(52) U.S. Cl. CPC G01N 21/53; G01S 7/4817; G01S 17/88; G01S 17/04

(57) ABSTRACT

A scanner of an optical detection system includes a housing, a light source associated with the housing operable to emit a light pulse into an area being scanned, a light sensitive device associated with the housing operable to detect a reflected light pulse from the area being scanned and an actuator for moving the light pulse through the area being scanned. The actuator comprises a solid state flexible polymer deformable in response to application of a voltage to the solid state flexible polymer.

### BACKGROUND

Embodiments of the disclosure relate generally to a detection system associated with a predetermined space and, more particularly, to an actuator for use with a beam based optical detection systems.

Light detection and ranging, and other beam based optical detection systems may be used to detect the presence of smoke and other particulates within a space. These systems include one or more sensors or non-contact measurement devices that work by emitting a very narrow light pulse and analyzing the reflection of the light pulse from an object. To evaluate a two or three dimensional area from a single observation position, these sensors typically includes either multiple beams or a movable optical surface.

Actuators are commonly used to rotate the optical surface to reflect the emitted light through an area. However, such actuation systems have several disadvantages. For example, the motor and corresponding mechanical system increases the size and weight of each sensor. In addition, due to the mechanical nature of the actuation system, the overall reliability of the system is limited, and the costs associated with maintenance are high. In addition, existing actuation systems typically consume substantial amounts of power and have existing operating limitations over the range of actuation.

### BRIEF DESCRIPTION

According to an embodiment, a scanner of an optical detection system includes a housing, a light source associated with the housing operable to emit a light pulse into an area being scanned, a light sensitive device associated with the housing operable to detect a reflected light pulse from the area being scanned and an actuator for moving the light pulse through the area being scanned. The actuator comprises a solid state flexible polymer deformable in response to application of a voltage to the solid state flexible polymer.

In addition to one or more of the features described above, or as an alternative, in further embodiments the actuator rotates at least one of the light source and the light sensitive device of the scanner about at least one axis.

In addition to one or more of the features described above, or as an alternative, in further embodiments comprising an optical surface associated with the housing and the actuator, the actuator being operable to rotate the optical surface about at least one axis relative to the housing.

In addition to one or more of the features described above, or as an alternative, in further embodiments the actuator is directly coupled to the optical surface.

In addition to one or more of the features described above, or as an alternative, in further embodiments the actuator is indirectly coupled to the optical surface.

In addition to one or more of the features described above, or as an alternative, in further embodiments comprising: a shaft supporting the optical surface; and a coupling disposed between the actuator and the shaft, wherein movement of the actuator is transmitted to the shaft by the coupling.

In addition to one or more of the features described above, or as an alternative, in further embodiments the actuator further comprises a first electrode and a second electrode operable to apply the voltage to the solid state flexible polymer.

In addition to one or more of the features described above, or as an alternative, in further embodiments deformation of the solid state flexible polymer comprises bending of the solid state flexible polymer.

In addition to one or more of the features described above, or as an alternative, in further embodiments deformation of the solid state flexible polymer comprises at least one of linear elongation and linear compression of the solid state flexible polymer.

In addition to one or more of the features described above, or as an alternative, in further embodiments the solid state flexible polymer comprises an electroactive polymer.

In addition to one or more of the features described above, or as an alternative, in further embodiments the solid state flexible polymer comprises a piezoelectric material.

In addition to one or more of the features described above, or as an alternative, in further embodiments the solid state flexible polymer comprises a dielectric polymer.

In addition to one or more of the features described above, or as an alternative, in further embodiments the solid state flexible polymer comprises an ionic polymer.

According to another embodiment, a smoke detection system includes a central processing unit and at least one scanner in communication with the central processing unit. The at least one scanner comprises a light sensitive device operable to detected a reflected light pulse from the area being scanned and an actuator for moving the light pulse through the area being scanned. The light sensitive device is arranged in communication with the central processing unit. The actuator is operated by the central processing unit and comprising a solid state flexible polymer deformable in response to application of a voltage to the solid state flexible polymer.

In addition to one or more of the features described above, or as an alternative, in further embodiments comprising a housing, the light sensitive device being coupled to the housing.

In addition to one or more of the features described above, or as an alternative, in further embodiments the actuator further comprises a first electrode and a second electrode operable to apply the voltage to the solid state flexible polymer.

In addition to one or more of the features described above, or as an alternative, in further embodiments the at least one scanner comprises a plurality of scanners arranged at distinct locations.

According to yet another embodiment, a method of detecting an object or particle within an area being monitored includes emitting a light pulse from at least one scanner into the area being monitored, moving at least a portion of the scanner such that the emitted light pulse moves through the area being scanned. Moving at least a portion of the scanner comprises applying a voltage to an actuator comprising a solid state flexible polymer. The method additionally includes receiving a reflected light pulse at the at least one scanner and analyzing the reflected light pulse to determine the presence of the object or particle.

In addition to one or more of the features described above, or as an alternative, in further embodiments comprising receiving a command at the at least one scanner, wherein moving at least a portion of the scanner occurs in response to the command.

In addition to one or more of the features described above, or as an alternative, in further embodiments comprising generating the command from a central processing unit arranged in communication with the at least one scanner.

In addition to one or more of the features described above, or as an alternative, in further embodiments moving the at least a portion of the scanner comprises rotating the scanner about a first axis.

In addition to one or more of the features described above, or as an alternative, in further embodiments moving the at least a portion of the scanner comprises rotating the scanner about a second axis.

In addition to one or more of the features described above, or as an alternative, in further embodiments applying a voltage to an actuator comprising a solid state flexible polymer results in deformation of the solid state flexible polymer.

In addition to one or more of the features described above, or as an alternative, in further embodiments deforming the solid state flexible polymer to achieve a desired movement of the actuator comprises bending the solid state flexible polymer.

In addition to one or more of the features described above, or as an alternative, in further embodiments deforming the solid state flexible polymer comprises linearly contracting the solid state flexible polymer.

In addition to one or more of the features described above, or as an alternative, in further embodiments deforming the solid state flexible polymer comprises linearly expanding the solid state flexible polymer.

In addition to one or more of the features described above, or as an alternative, in further embodiments upon determining the presence of the object or particle, rotating the at least a portion of the scanner directly to a location associated with the object or particle.

### BRIEF DESCRIPTION OF THE DRAWINGS

The following descriptions should not be considered limiting in any way. With reference to the accompanying drawings, like elements are numbered alike:

FIG. 1 is a schematic diagram of an optical detection system associated with a building;

FIG. 2 is a schematic diagram of a scanner of an optical detection system;

FIG. 3 is a perspective view of a scanner of an optical detection system;

FIG. 4 is a perspective view of another scanner of an optical detection system;

FIG. 5 is a perspective view of a light pulse emission within a region surrounding the scanner;

FIG. 6A is a cross-sectional view of a solid state flexible actuator in a non-actuated state according to an embodiment;

FIG. 6B is a cross-sectional view of a solid state flexible actuator in an actuated state according to an embodiment;

FIG. 7 is a perspective view of a mirror directly coupled to a solid state flexible actuator according to an embodiment;

FIG. 8 is a perspective view of a solid state flexible actuator indicating the various bending movement achievable according to an embodiment; and

FIG. 9 is a perspective view of a mirror indirectly coupled to a solid state flexible actuator according to an embodiment.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

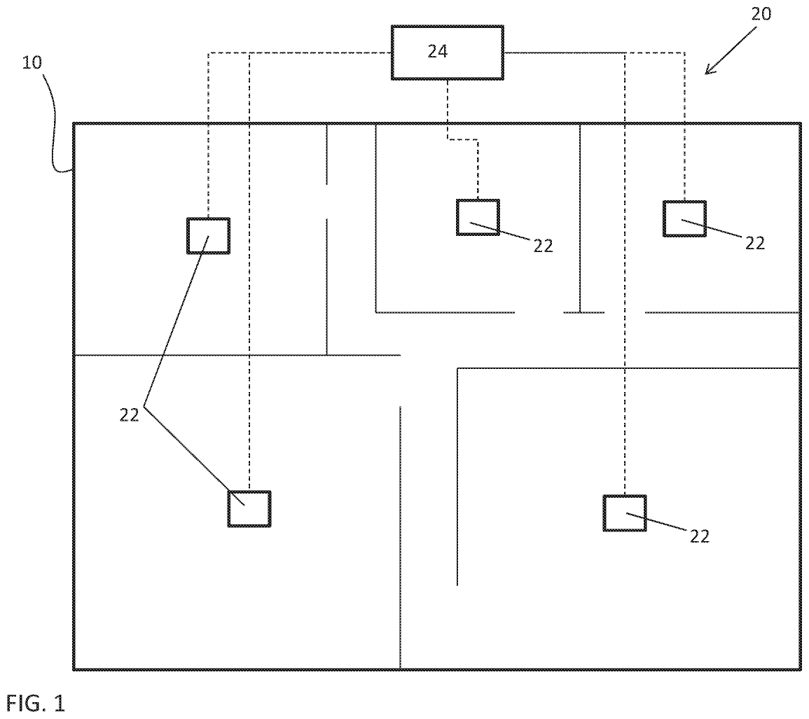

With reference now to FIG. 1, an optical system 20 for monitoring one or more conditions, such as the presence of smoke, fire, or other contaminants within an environment 10 is illustrated. As shown, the optical system 20 includes one or more non-contact measurement devices 22 arranged at various positions, such as rooms for example, throughout the building or area 10 being monitored. By positioning the non-contact measurement devices 22 at distinct positions or locations, a larger space or area may be monitored by the optical system. In addition, inclusion of multiple non-contact measurement devices 22 at distinct positions allows for more accurate detection of an object or particle.

In the illustrated, non-limiting embodiment, each of the non-contact measurement devices 22 is operably coupled or in communication with a central processing unit or station 24. The connection between the non-contact measurement devices 22 and the central processing unit 24 may include a wired, a wireless, or optical connection, or any other suitable type of connection known in the art. However, in other embodiments, the system 20 may include a plurality of processing units 24, for example such that each non-contact measurement device 22 is associated with a corresponding processing unit 24. The plurality of processing units 24 may be separate from or integrally formed with the non-contact measurement devices 22. In an embodiment, the non-contact measurement devices 22 emit a light pulse and analyze a reflected light pulse to determine the presence of an object or particle within the space being monitored. Examples of such optical systems 20 include but are not limited to a Light detection and ranging (LIDAR) system, a fiber optic beam detection system, and as well as passive optical sensors like a passive infrared security sensor for example.

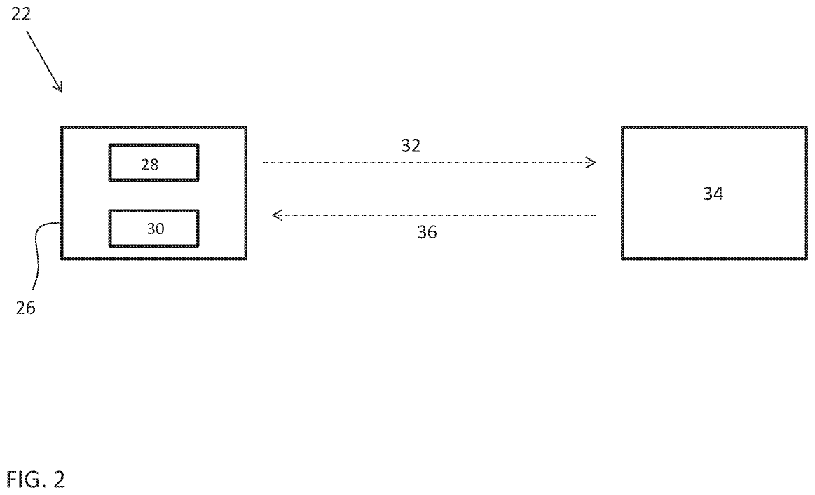

With reference to FIGS. 2-4, an example of an optical non-contact measurement device 22 of such an optical system 20 is illustrated. The optical non-contact measurement device 22 is referred to herein as a scanner. The scanner 22 includes a housing 26 containing a light source 28 and a light sensitive device 30, such as laser diode used for emitting a light pulse and a photodiode for receiving a light pulse. Any light source 28 operable to emit a light having a suitable wavelength, including but not limited to, infrared, ultraviolet, or light within the visible spectrum for example, may be used. The light source 28 may be selected based on not only the environment in which the non-contact measurement device is located, but also the type of particle or contaminant being targeted by the device 22 for detection. The light pulse, illustrated schematically at 32 in FIG. 2, emitted by the light source 28 is reflected by an object or particle 34 as a reflected pulse, illustrated schematically at 36, which is received by the detector 30.

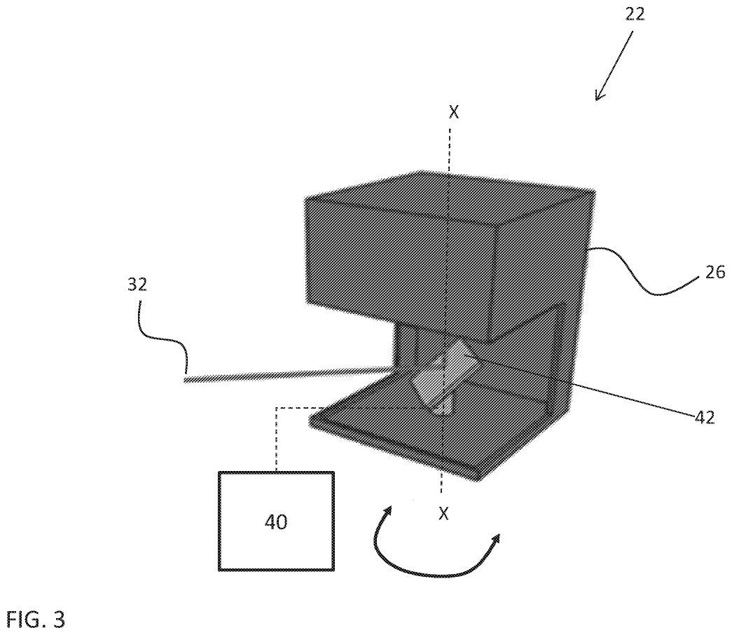

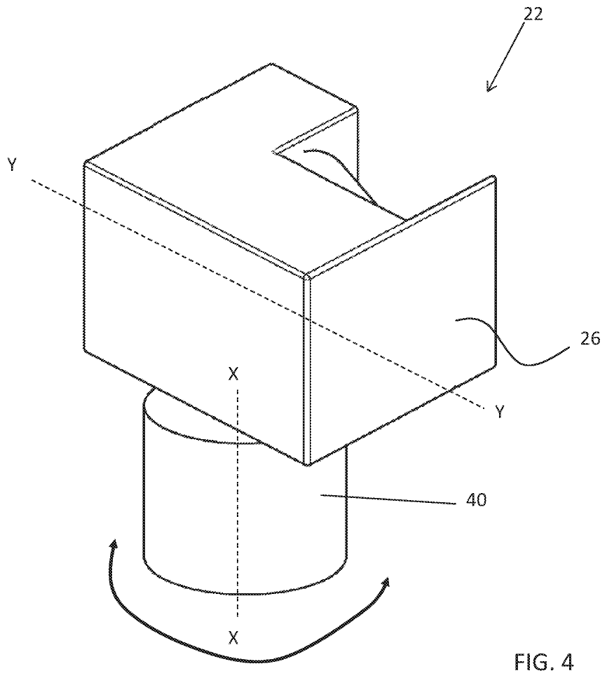

In order to scan a three dimensional (3D) area from a single location, one or more actuators 40 are operable to rotate one or more components (FIG. 3) of the scanner 22 to reflect the light pulse 32 through the area surrounding the scanner 22. In the non-limiting embodiment illustrated in FIG. 3, the one or more movable components of the scanner 22 includes an optical surface 42, such as a mirror for example, that is rotatable about an axis by the actuator 40. However, it should be understood that in other embodiments, the one or more actuators 40 may be operable to rotate the scanner 22 in its entirety, as shown in FIG. 4.

Electronics, such as wiring, a communication module, a memory, and the central processing unit 24, are used to process and calculate the precise coordinates of the scanned object or particle 34 based on the calculated travel time of the emitted and reflected pulses 32, 36 and the angles of displacement of the actuator 40 and the optical surface 42. As a result of the redirection of the light through the area, a map of precise distance measurements of the scene from the observation position of the scanner 22 may be created. However, in other embodiments, a scanning passive infrared detector could be used in place of the scanner. In such embodiments, the detector does not include a light source, and as a result, the central processing unit 24 may be configured to evaluate an area using only the light reflected from the area.

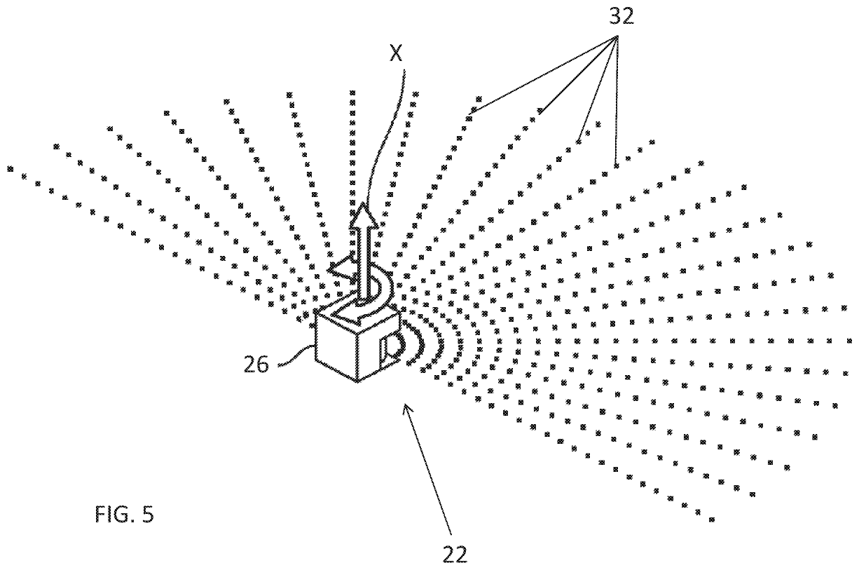

The optical surface 42 (or scanner 22) may be configured to rotate about at least one axis in both a first direction, and a second, opposite direction. In embodiments where the optical surface 42 (or scanner 22) is rotatable about a plurality of axes, a first axis of rotation and a second axis of rotation may be oriented substantially perpendicular to one another. In the illustrated, non-limiting embodiment of FIG. 3, the optical surface 42 is rotatable about at least a vertically oriented axis X. However, in other embodiments, the at least one axis may be a horizontally oriented axis Y, as shown in FIG. 4. Referring to FIG. 5, rotation of the optical surface 42 (or scanner 22) about the vertical axis X, results in a two dimensional distribution of emitted pulses, represented by the straight dotted lines in a horizontal plane 32. Similarly, rotation of the optical surface 42 (or scanner 22) about a horizontally oriented axis Y would result in a two dimensional distribution of emitted pulses in a vertical plane. Accordingly, rotation of the optical surface 42 (or scanner 22) about both the vertical and horizontal axes X, Y results in a distribution of emitted pulses through a three dimensional space.

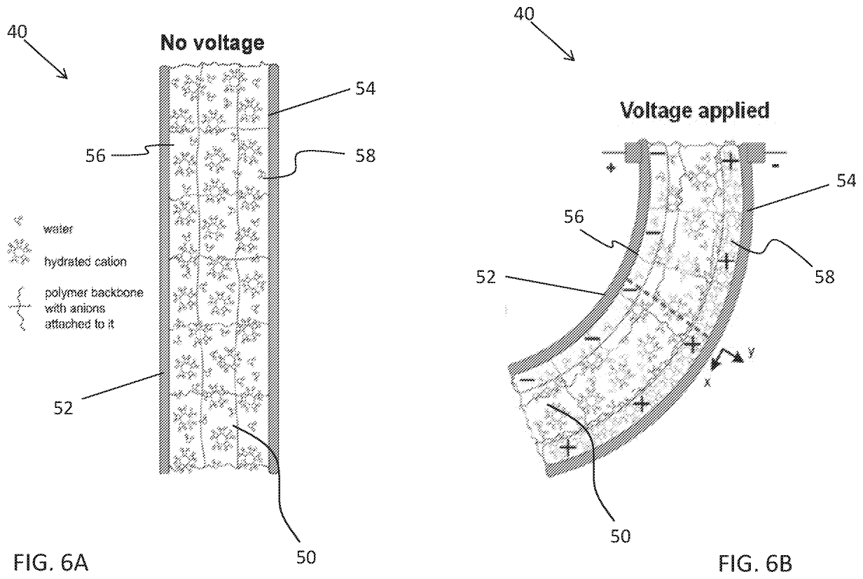

In existing optical detection systems 20, the actuator(s) 40 used to move the optical surface 42 or the scanner 22 is typically an electromagnetic motor. With reference now to FIGS. 6-9, in an embodiment, the actuator 40 configured to move the optical surface 42 is a solid state flexible actuator operable by transforming electrical energy into mechanical energy. Examples of a solid state flexible actuators include, but are not limited to an electroactive polymer based actuator, a dielectric polymer actuator, an ionic polymer actuator, a piezoelectric material, or any other suitable stimuli responsive polymer.

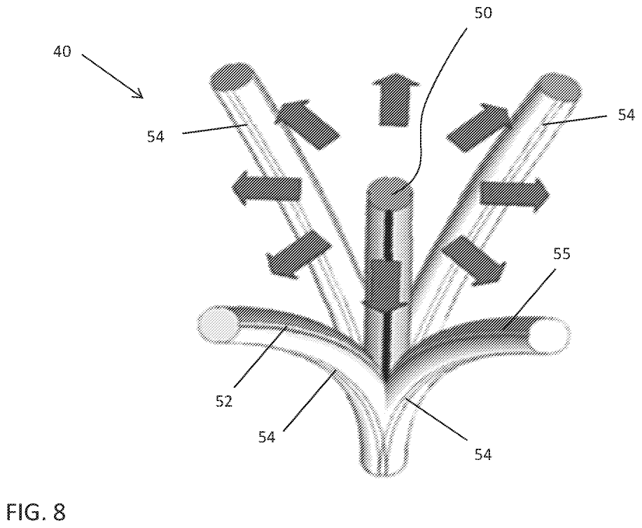

An embodiment of a solid state flexible actuator 40 is shown in FIG. 6A. As shown, the actuator 40 includes a portion of an electroactive polymer 50 that acts as an insulating dielectric between two electrodes 52, 54. In the illustrated, non-limiting embodiment, the electroactive polymer includes water and hydrated cation molecules supported by a polymer backbone having anions attached thereto. However, an electroactive polymer 50 having any suitable construction is contemplated herein. The electroactive polymer 50 may deflect upon application of a voltage difference between the two electrodes 52, 54 (a ‘dielectric elastomer’). As shown, the first electrode 52 and the second electrode 54 are attached to the polymer 50 at a first surface 56 and a second surface 58, respectively, to provide a voltage difference across polymer 50, or to receive electrical energy from the polymer 50. However, it should be understood that embodiments where the actuator 40 includes more than two electrodes are also contemplated herein. For example, in FIG. 8 multiple electrodes, illustrated at 52, 54, and 55 are fabricated at various angular locations about the electroactive polymer rod 50. Accordingly, the voltage may be controlled between any pair of the plurality of electrodes to facilitate movement of the polymer 50 in a plurality of directions. As shown, inclusion of multiple electrodes provides enhanced control of the movement of the polymer rod 50.

As best illustrated in FIG. 8, the polymer 50 may deflect in response to a change in electric field provided by the electrodes 52, 54. With reference now to FIG. 6B, an example of the actuator 40 when deflected is illustrated. As shown, the electrodes 52, 54 are generally compliant and change shape with the polymer 50. Deflection of the polymer 50 in response to a change in electric field provided by the electrodes 52, 54, indicated by the negative and positive signs arranged adjacent the edges of the polymer 50 is referred to as ‘actuation’. Actuation typically involves the conversion of electrical energy to mechanical energy. As the polymer 50 changes in size, the deflection may be used to produce mechanical work. As used herein, the term “deflection” may refer to any displacement, expansion, contraction, torsion, linear or area strain, or any other deformation of a portion of the polymer.

For actuation, the polymer 50 generally continues to deflect until the mechanical forces balance the electrostatic forces driving the deflection. The mechanical threes include elastic restoring forces of the polymer material 50, the compliance of electrodes 52, 54, and any external resistance provided by a device and/or load coupled to the actuator 40. The deflection of the actuator 40 as a result of an applied voltage may also depend on a number of other factors such as the polymer dielectric constant and the size of polymer 50. In an embodiment, the electroactive polymer actuator 40 is capable of deflection. in any direction.

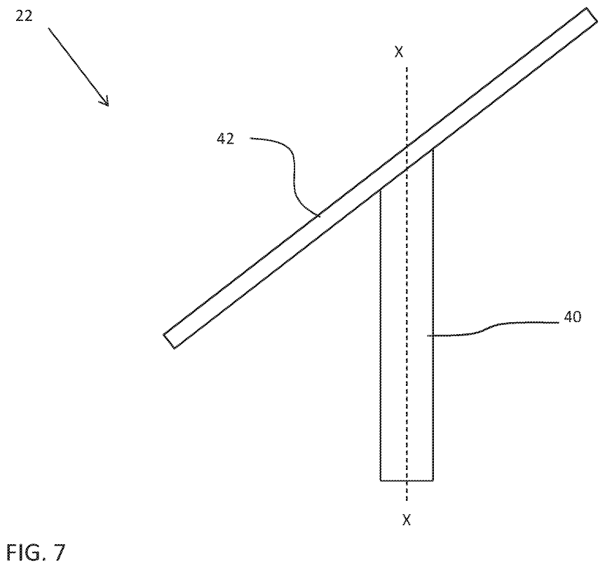

In the illustrated, non-limiting embodiments, the actuator 40 is generally cylindrical in shape, generated by rolling one or more sheets of polymer 50. However, it should be understood that any suitable shape is contemplated herein. Further, the solid state flexible actuator 40 may be directly coupled to optical surface 42 or the scanner 22 as shown in FIG. 7. In such embodiments, deflection of the actuator 40 may include bending due to the displacement of the ions within the matrix of the polymer material 50. By controlling the magnitude and direction of a voltage difference between the electrodes 52, 54 of the actuator 40, the direction of bending of the actuator 40 may be manipulated to rotate the optical surface 42 or scanner 22 about an axis, such as vertical axis X for example.

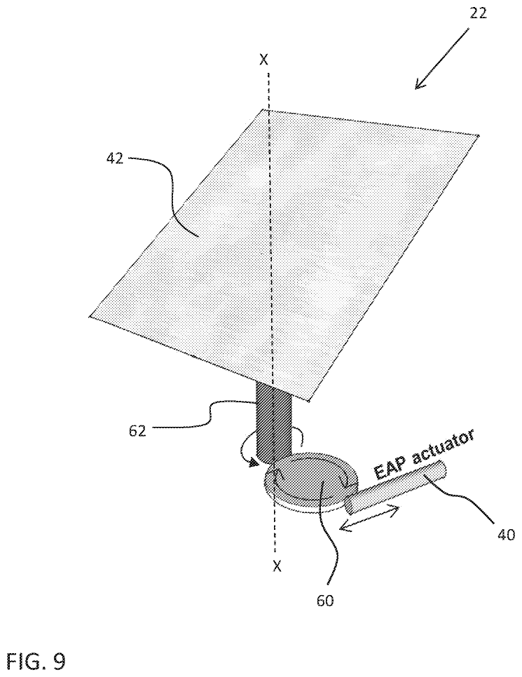

Alternatively, the actuator 40 may be indirectly coupled to the optical surface 42 or scanner 22, as shown in FIG. 9 such as via a coupling or connector fix example. In such embodiments, the actuator 40 may be constructed to achieve a linear deflection, resulting in elongation or compression of the actuator 40. In the illustrated, non-limiting embodiment, this linear movement of the actuator 40 may be used to drive rotation of a coupling 60 about an axis. The coupling 60 may be directly or indirectly engaged with a shaft 62 supporting the optical surface 42 or scanner 22 such that the rotation of the coupling 60 is transmitted to the shaft 62 to rotate the optical surface 42.

Use of a solid state flexible actuator 40 to control movement of the scanner or the optical surface 42 provides better control than existing actuators 40. Because the solid state flexible actuator 40 has a limited number of moving parts, the overall reliability of the scanner 22 is increased. Further, the actuator 40 is very light weight and small in size, requiring extremely low power for operation. As a result, the cost of such an actuator 40, as well as the cost of operating such an actuator 40, is potentially reduced compared to existing motors. In addition, a solid state flexible actuator 40 as described herein provides better control of movement relative to the scanning space, resulting in improved accuracy and response time. In embodiments where the scanner 22 is used to detect the presence of a smoke particle, a fire, or another contaminant, the actuator 40 may be operated to focus the optical surface 42 or scanner 22 at a known location, i.e. where the presence of a particle or object was detected. This direction of the optical surface 42 towards a specific location may occur without having to rotate the scanner 22 through the full range of motion and perform corresponding sampling associated with such rotation prior to reaching the desired location (each of which is likely to cause additional delay in evaluating a potentially hazardous detected condition).

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A scanner of an optical detection system comprising:
a housing;
a light source associated with the housing operable to emit a light pulse into an area being scanned;
a light sensitive device associated with the housing operable to detect a reflected light pulse from the area being scanned; and
an actuator for moving the light pulse through the area being scanned, the actuator comprising a solid state flexible polymer deformable in response to application of a voltage to the solid state flexible polymer.

2. The scanner of claim 1, wherein the actuator rotates at least one of the light source and the light sensitive device of the scanner about at least one axis.

3. The scanner of claim 1, further comprising:
an optical surface associated with the housing and the actuator, the actuator being operable to rotate the optical surface about at least one axis relative to the housing.

4. The scanner of claim 3, wherein the actuator is directly coupled to the optical surface.

5. The scanner of claim 3, wherein the actuator is indirectly coupled to the optical surface.

6. canceled

7. The scanner of claim 1, wherein the actuator further comprises a first electrode and a second electrode operable to apply the voltage to the solid state flexible polymer.

8. The scanner of claim 1, wherein deformation of the solid state flexible polymer comprises bending of the solid state flexible polymer.

9. The scanner of claim 1, wherein deformation of the solid state flexible polymer comprises at least one of linear elongation and linear compression of the solid state flexible polymer.

10. The scanner of claim 1, wherein the solid state flexible polymer comprises an electroactive polymer.

11. The scanner of claim 1, wherein the solid state flexible polymer comprises a piezoelectric material.

12. The scanner of claim 1, wherein the solid state flexible polymer comprises a dielectric polymer.

13. The scanner of claim 1, wherein the solid state flexible polymer comprises an ionic polymer.

14. A smoke detection system comprising:
a central processing unit; and
at least one scanner in communication with the central processing unit, the at least one scanner comprising:
a light sensitive device operable to detected a reflected light pulse from the area being scanned, the light sensitive device being arranged in communication with the central processing unit; and
an actuator for moving the light pulse through the area being scanned, the actuator being operated by the central processing unit and comprising a solid state flexible polymer deformable in response to application of a voltage to the solid state flexible polymer.

15. The smoke detection system of claim 14, further comprising a housing, the light sensitive device being coupled to the housing.

16. The smoke detection system of claim 14, wherein the actuator further comprises a first electrode and a second electrode operable to apply the voltage to the solid state flexible polymer.

17. The smoke detection system of claim 14 wherein the at least one scanner comprises a plurality of scanners arranged at distinct locations.

18. A method of detecting an object or particle within an area being monitored comprising:
emitting a light pulse from at least one scanner into the area being monitored;
moving at least a portion of the scanner such that the emitted light pulse moves through the area being scanned, wherein moving at least a portion of the scanner comprises applying a voltage to an actuator comprising a solid state flexible polymer;
receiving a reflected light pulse at the at least one scanner; and
analyzing the reflected light pulse to determine the presence of the object or particle.

19. The method of claim 18, further comprising receiving a command at the at least one scanner, wherein moving at least a portion of the scanner occurs in response to the command.

20. The method of claim 19, further comprising generating the command from a central processing unit arranged in communication with the at least one scanner.

21. The method of claim 18, wherein moving the at least a portion of the scanner comprises rotating the scanner about a first axis.

22. canceled

23. canceled

24. canceled

25. canceled

26. canceled

27. The method of claim 18, wherein upon determining the presence of the object or particle, rotating the at least a portion of the scanner directly to a location associated with the object or particle.
